(19) United States
(12) Patent Application Publication
(10) Pub. No.: US 2010/0160165 A1
(43) Pub. Date: Jun. 24, 2010

(54) AQUEOUS ACTIVE INGREDIENT CONCENTRATE HAVING AN HERBICIDAL EFFECT

(75) Inventors: Matthias Bratz, Maxdorf (DE); Rainer Berghaus, Speyer (DE); Ulrich Steinbrenner, Neustadt (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/376,310

(22) PCT Filed: Aug. 3, 2007
(86) PCT No.: PCT/EP2007/058092

§ 371 Date: Feb. 4, 2009

(30) Foreign Application Priority Data
Aug. 4, 2006 (EP) 06118443.8

(51) Int. Cl. A01N 43/56

(52) U.S. Cl. 504/282

(57) ABSTRACT

The present invention relates to aqueous active compound concentrates having herbicidal action. The compound contains, in dissolved form:
c) at least one 4-benzoyl-substituted pyrazole compound of the formula I

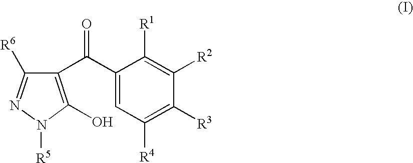

in which
R¹ and R³ independently of one another are hydrogen, halogen, methyl, halomethyl, methoxy, halomethoxy, methylthio, methylsulfinyl or methylsulfonyl;
R² is a 5-membered heterocyclic radical which is unsubstituted or carries 1, 2, 3 or 4 substituents selected from the group consisting of halogen, C₁-C₆-alkyl, C₁-C₄-alkoxy, C₁-C₄-haloalkoxy and C₁-C₄-alkylthio;
R⁴ is hydrogen, halogen or methyl;
R⁵ is C₁-C₆-alkyl, C₃-C₆-cycloalkyl or C₃-C₆-cycloalkylmethyl; and
R⁶ is hydrogen or C₁-C₄-alkyl;
or one of its agriculturally useful salts; and
d) at least one benzoic acid derivative of the formula II

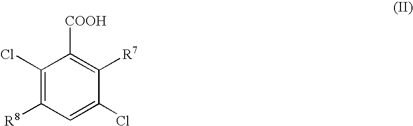

in which
R⁷ is hydrogen, halogen, hydroxyl or methoxy and
R⁸ is hydrogen, halogen or amino;
or one of its agriculturally useful salts.

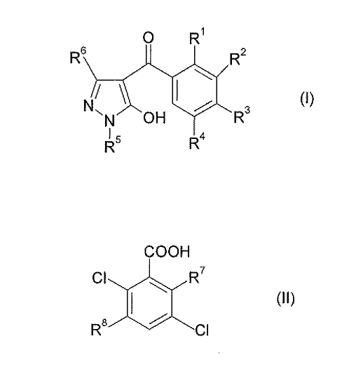

The present invention relates to aqueous active compound concentrates having herbicidal action comprising, in dissolved form:

a) at least one 4-benzoyl-substituted pyrazole compound of the formula I

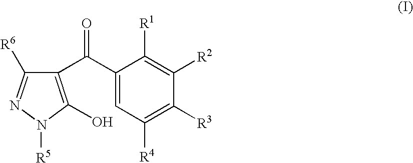

in which
R¹, R³ independently of one another are hydrogen, halogen, methyl, halomethyl, methoxy, halomethoxy, methylthio, methylsulfinyl or methylsulfonyl;
R² is a 5-membered heterocyclic radical which is unsubstituted or carries 1, 2, 3 or 4 substituents selected from the group consisting of halogen, C₁-C₆-alkyl, C₁-C₄-alkoxy, C₁-C₄-haloalkyl, C₁-C₄-haloalkoxy and C₁-C₄-alkylthio;
R⁴ is hydrogen, halogen or methyl;
R⁵ is C₁-C₆-alkyl, C₃-C₆-cycloalkyl or C₃-C₆-cycloalkylmethyl; and
R⁶ is hydrogen or C₁-C₄-alkyl;
or one of its agriculturally useful salts; and
   b) at least one benzoic acid derivative of the formula II

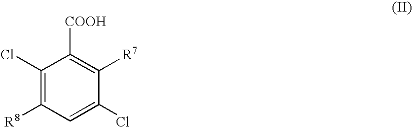

in which
R⁷ is hydrogen, halogen, hydroxyl or methoxy and
R⁸ is hydrogen, halogen or amino;
or one of its agriculturally useful salts.

Pure crops of agriculturally interesting useful plants are required for efficient and profitable practice of industrialized agriculture and for ensuring a consistent product quality. The selective sensitivity of different plant groups with respect to certain metabolic inhibitors or other cell toxins may be utilized for the targeted control of unwanted foreign vegetation (growth of harmful plants) on the areas under agricultural cultivation. Here, it is desirable in principle to enhance both the absolute efficacy and the specificity of the active compounds used (herbicides) against harmful plants.

The specificity and, within certain limits, the absolute efficacy can be enhanced by using combinations of a plurality of specific active compounds which attack at different points of the metabolism of the target plants. If the activity of the combination exceeds the sum of the individual activities significantly, this is referred to as synergism (occasionally also as superadditive effects).

The absolute efficacy of crop protection agents can be increased by various types of accompanying substances and auxiliaries which may enhance the desired activity in various ways. Further additives may be used to simplify handling, to increase storability and to improve other product properties.

An important role in the formulation of herbicidally active compounds is played by “adjuvants”. These are to be understood as auxiliaries which increase the activity of an active compound and/or its selectivity for the harmful plant, but which per se have minute, if any, activity against the harmful plant to be controlled. In many cases, the activity of adjuvants for herbicides is based on their surface activity which improves contact of the application form of the active compound, in general an aqueous active compound-containing spray liquor, with the surface of the plant and, by reducing surface tension, improves penetration of the application form and thus the active compound into the soil. Whether a particular surfactant acts as adjuvant, i.e. whether it achieves enhanced activity or selectivity, frequently depends on the nature of the active compound.

In general, adjuvants are added only immediately prior to the application of the active compound of the application form, for example the spray liquor. However, in principle, they may also be a constituent of an active compound formulation, and this is preferred for reasons of handling and application safety. However, many active compounds are incompatible with the customary surfactants, in particular on prolonged storage. Here, incompatibility means any chemical or physicochemical reduction of activity or reduction of practical applicability, which may be the result either of direct chemical reaction of active compounds and auxiliaries or of a reduced availability of the active compounds in the mixture, for example by formation of precipitates which are poorly soluble under application conditions or by demixing of the formulation. There may also be incompatibility with the other constituents of the formulation. Accordingly, it is regularly necessary to match adjuvants and the active compound to be formulated, and also the other constituents of the formulation.

WO 99/63823 discloses to improve the activity of 4-benzoyl-substituted pyrazole compounds by adding relatively large amounts of nitrogenous fertilizers and adjuvants. Thus, on application, large amounts of fertilizer are applied, which may have a negative effect on selectivity.

WO 00/53014 discloses to increase the activity of herbicidal 4-benzoyl-substituted pyrazole compounds by using an adjuvant which comprises a mixture of a fatty acid, a phosphoric acid or sulfuric acid semiester of a monohydroxy functional polyalkyl ether and a C₁-C₅-alkyl C₁₀-C₂₀-alkanoate. When this adjuvant is incorporated into aqueous concentrate formulations of the 4-benzoyl-substituted pyrazole compounds, there may be homogeneity problems. Also, the active compound may precipitate in the spray liquor obtained on dilution. For this reason, such adjuvants are added only shortly prior to application of the aqueous spray liquor (tank mix method).

WO 99/65314 describes inter alia synergistically active herbicide mixtures comprising a herbicidally active 4-benzoyl-substituted pyrazole compound, for example one of the compounds I defined at the outset, and a synergist, for example a herbicide from the group of the benzoic acid compounds, for example one of the compounds of the formula II defined at the outset. However, the herbicidally active benzoic acid compounds frequently also damage useful plants. The incorporation of adjuvants into water-soluble concentrate formulations of active compound mixtures comprising 4-benzoyl-substituted pyrazole compounds of the formula I and benzoic acid compounds of the formula II is frequently associated with problems. In particular if relatively large amounts of adjuvants and/or higher concentrations of benzoic acid compound are used, there are frequently inhomogeneities or solids separating out.

Accordingly, it was an object of the present invention to provide an aqueous homogeneous formulation comprising at least one compound of the formula I together with at least one compound of the formula II and a relatively large amount of an adjuvant, which formulation is storage-stable. In addition, the formulation was to be dilutable with water without any problems.

Surprisingly, it has now been found that these and other objects are achieved by using the nonionic surfactants S described below.

Accordingly, the present invention provides aqueous active compound concentrates comprising, in dissolved form:
a) at least one 4-benzoyl-substituted pyrazole compound of the formula I, as defined at the outset;
b) at least one benzoic acid compound of the formula II, as defined at the outset; and
c) at least one nonionic surfactant S, selected from polyether compounds having repeat units derived from ethylene oxide, alkylpolyglycosides and mixtures thereof.

The active compound concentrates according to the invention are homogeneous aqueous solutions of the active compounds of the formulae I and II. The concentrates are storage-stable and, even after prolonged storage, show no tendency for solids to separate off, even when large amounts of surfactant S are present. The active compound concentrates are easy to handle and can be diluted with water without active compounds separating off. Moreover, it has been found that, by using these nonionic surfactants S, it is possible not only to increase the herbicidal activity of the active compound mixture to exceed the already known synergy of the active compounds I and II, but also to reduce the damaging effect of the active compounds of the formula II on the agriculturally useful plants.

Here and below, alkyl and the alkyl moieties in alkylcarbonyl, alkoxy, alkylthio and alkylphenyl, are straight-chain or branched saturated hydrocarbon radicals. Correspondingly, alkenyl denotes straight-chain or branched hydrocarbon radicals which are monounsaturated. Haloalkyl and the haloalkyl moieties in haloalkoxy denote straight-chain or branched alkyl radicals in which 1 or more, for example 1, 2, 3, 4, 5 or else all, hydrogen atoms are replaced by halogen, in particular by chlorine or fluorine. Phenylalkyl denotes a phenyl radical which is attached via an alkyl group to the remainder of the molecule. Cycloalkyl denotes cyclic saturated hydrocarbon radicals. The prefix Cₙ-Cₘ indicates in each case the number of possible carbon atoms.

Examples of alkyl are C₁-C₄-alkyl, such as methyl, ethyl, propyl, 1-methylethyl, butyl, 1-methylpropyl, 2-methylpropy 1 and 1,1-dimethylethyl, furthermore C₁-C₆-alkyl which, in addition to the radicals mentioned for C₁-C₄-alkyl, also includes pentyl, 1-methylbutyl, 2-methylbutyl, 3-methylbutyl, 2,2-di-methylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl, and also relatively long-chain alkyl radicals, such as n-heptyl, n-octyl, n-nonyl, isononyl, 2-ethylhexyl, n-decyl, isodecyl, 2-propylheptyl, dodecyl, tridecyl, isotridecyl, pentadecyl, lauryl, myristyl, palmityl, stearyl, behenyl and the like.

Alkylcarbonyl denotes an alkyl radical as mentioned above which is attached via a carbonyl group.

Alkoxy denotes an alkyl radical as defined above, which is attached via oxygen, in particular C₁-C₄-alkoxy, such as methoxy, ethoxy, propoxy, 1-methylethoxy, butoxy, 1-methylpropoxy, 2-methylpropoxy and 1,1-dimethylethoxy.

Haloalkyl denotes an alkyl radical as defined above in which one or more, for example 1, 2, 3, 4 or 5 or all, hydrogen atoms are replaced by halogen, in particular by fluorine or chlorine. Examples are fluoromethyl, chloromethyl, trifluoromethyl, difluoroethyl, 2,2,2-trifluoroethyl, pentafluoroethyl 2-fluoro-1-methylethyl, 2,2,2-trifluoro-1-methylethyl, etc.

Cycloalkyl denotes a cyclic saturated hydrocarbon radical, such as, for example, cyclopentyl, cyclohexyl, cycloheptyl.

Phenylalkyl denotes a phenyl radical which is attached via an alkyl group, such as, for example, benzyl, 1- or 2-phenylethyl.

5-membered heterocyclic radicals are saturated, partially saturated or aromatic cycles which have 5 ring atoms (ring members) and which, in addition to the carbon atoms as ring members, have one or more, for example 1, 2, 3 or 4, heteroatoms, in particular 1 or 2 heteroatoms, as ring members, the heteroatoms preferably being selected from the group consisting of O, S and N. Examples of these radicals are 2-tetrahydrofuranyl, 3-tetrahydrofuranyl, 2-tetrahydrothienyl, 3-tetrahydrothienyl, 2-pyrrolidinyl, 3-pyrrolidinyl, 3-isoxazolidinyl, 4-isoxazolidinyl, 5-isoxazolidinyl, 3-isothiazolidinyl, 4-isothiazolidinyl, 5-isothiazolidinyl, 3-pyrazolidinyl, 4-pyrazolidinyl, 5-pyrazolidinyl, 2-oxazolidinyl, 4-oxazolidinyl, 5-oxazolidinyl, 2-thiazolidinyl, 4-thiazolidinyl, 5-thiazolidinyl, 2-imidazolidinyl, 4-imidazolidinyl, 1,2,4-oxadiazolidin-3-yl, 1,2,4-oxadiazolidin-5-yl, 1,2,4-thiadiazolidin-3-yl, 1,2,4-thiadiazolidin-5-yl, 1,2,4-triazolidin-3-yl, 1,3,4-oxadiazolidin-2-yl, 1,3,4-thiadiazolidin-2-yl, 1,3,4-triazolidin-2-yl, 2,3-dihydrofur-2-yl, 2,3-dihydrofur-3-yl, 2,4-dihydrofur-2-yl, 2,4-dihydrofur-3-yl, 2,3-dihydrothien-2-yl, 2,3-dihydrothien-3-yl, 2,4-dihydrothien-2-yl, 2,4-dihydrothien-3-yl, 2-pyrrolin-2-yl, 2-pyrrolin-3-yl, 3-pyrrolin-2-yl, 3-pyrrolin-3-yl, 2-isoxazolin-3-yl, 3-isoxazolin-3-yl, 4-isoxazolin-3-yl, 2-isoxazolin-4-yl, 3-isoxazolin-4-yl, 4-isoxazolin-4-yl, 2-isoxazolin-5-yl, 3-isoxazolin-5-yl, 4-isoxazolin-5-yl, 2-isothiazolin-3-yl, 3-isothiazolin-3-yl, 4-isothiazolin-3-yl, 2-isothiazolin-4-yl, 3-isothiazolin-4-yl, 4-isothiazolin-4-yl, 2-isothiazolin-5-yl, 3-isothiazolin-5-yl, 4-isothiazolin-5-yl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 3,4-dihydrooxazol-5-yl, 3,4-dihydrooxazol-2-yl, 3,4-dihydrooxazol-3-yl, 3,4-dihydrooxazol-4-yl, 2-furyl, 3-furyl, 2-thienyl, 3-thienyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, 1,2,4-oxadiazol-3-yl, 1,2,4-oxadiazol-5-yl, 1,2,4-thiadiazol-3-yl, 1,2,4-thiadiazol-5-yl, 1,2,4-triazol-3-yl, 1,3,4-oxadiazol-2-yl, 1,3,4-thiadiazol-2-yl, 1,3,4-triazol-2-yl, pyrrol-1-yl, pyrazol-1-yl, imidazol-1-yl, 1,2,3-triazol-1-yl and 1,2,4-triazol-1-yl.

According to a first embodiment, substance S comprises a polyether compound having repeat units derived from ethylene oxide, i.e. repeat units of the formula CH₂CH₂O, and, if appropriate, further repeat units derived from C₃-C₈-alkylene oxides and/or styrene oxide, or a mixture thereof with alkylpolyglycosides. In this embodiment, the polyether compound accounts in particular for at least 80% by weight, particularly preferably at least 90% by weight or the total amount of substance S.

Such polyether compounds typically have at least one, for example, 1, 2, 3 or 4, polyether groups which, in addition to the repeat units derived from ethylene oxide, may optionally have further repeat units which are generally derived from C₃-C_{g}-alkylene oxides and/or styrene oxide. Hereinbelow, the polyether groups are also referred to as macrogol moiety. In the polyether compounds, the polyether groups are generally covalently attached to an organic radical (basic moiety) or attached via an ether oxygen atom to a macromolecule.

The covalent attachment of the macrogol moiety (moieties) to the basic moiety is generally via an oxygen, sulfur or nitrogen atom, preferably via an oxygen atom. The basic moiety is typically an organic radical having generally 4 to 40, frequently 6 to 30 and in particular 10 to 22 carbon atoms, where the basic moiety may optionally also have one or more functional groups, for example 1 or 2 carbonyloxy groups (C(═O)—O-groups) and/or 1, 2, 3 or 4 OH groups and/or 1, 2, 3, 4, 5 or 6 nitrogen atoms. Examples of radicals suitable as basic moiety are C₈-C₃₀-alkenyl, C₄-C₃₀-alkanediyl, C₈-C₃₀-alkantriyl, C₅-C₁₀-cycloalkyl, C₅-C₁₀-cycloalkanediyl, α,α′-[bisphenyl-C₁-C₄-alkane]diyl, α,α′-[biscyclohexyl-C₁-C₄-alkane]diyl, mono- and di-C₄-C₂₀-alkylphenyl, in particular butylphenyl, 4-test-butylphenyl, hexylphenyl, octylphenyl, nonylphenyl, dodecylphenyl, tridecylphenyl, C₈-C₂₀-alkylcarbonyl, benzoyl, C₁-C₂₀-alkylbenzoyl, naphthyl which may optionally have 1, 2 or 3 C₁-C₁₀-alkyl groups, mono-, di- and tristyrylphenyl, furthermore radicals derived from sorbitan esters, from alkylpolyglycosides, from mono- or diglycerides and also from (oligo)alkyleneimines.

Alkyl(poly)glycosides or alkylpolyglucosides are to be understood as meaning compounds having one or more, in particular one, alkyl radical, in particular a C₆-C₂₂-alkyl radical, which is attached via an oxygen atom to a mono- or oligosaccharide radical, for example to a mono-, di- or trisaccharide radical. Here, the saccharide units are typically derived from glucose. Preferred alkyl(poly)glycosides are those having on average 1 to 2 glucose units. In general, these are mixtures. In polyether compounds having a basic moiety derived from alkyl(poly)glycosides, the at least one macrogol moiety replaces at least one of the non-esterified hydroxyl groups of the mono- or oligosaccharide radical.

Sorbitan esters are to be understood as meaning esters, in particular mono- or diesters, of sorbitol with saturated or unsaturated aliphatic carboxylic acids, in particular saturated or unsaturated fatty acids having 8 to 22 carbon atoms. In polyether compounds having a basic moiety derived from sorbitan esters, the at least one macrogol moiety replaces at least one of the non-esterified hydroxyl groups of the sorbitan.

Mono- and diglycerides are to be understood as meaning mono- or diesters of glycerol or mixtures thereof with saturated or unsaturated aliphatic carboxylic acids, in particular saturated or unsaturated fatty acids having 8 to 22 carbon atoms. In polyether compounds having a basic moiety derived from mono- or diglycerides, the at least one macrogol moiety replaces at least one of the non-esterified hydroxyl groups of the glycerol.

Radicals derived from (oligo)alkyleneimines are to be understood as meaning radicals derived from alkylenediamines or oligomeric iminoalkyleneamines, such as mono-, di-, tri- and tetraethyleneimine or mono-, bis-, tris- or tetrakis-(3-aminopropyl)ethylenediainine. In polyether compounds having a basic moiety derived from (oligo)alkyleneimines, the at least one macrogol moiety replaces at least one NH hydrogen atom of the (oligo)alkyleneimine.

The percentage of the EO repeat units of the total weight of the polyether compounds is typically in the range of from 10 to 90% by weight and in particular in the range of from 30 to 85% by weight.

In general, the polyether compounds have an HLB according to Griffin of from 1.5 to 19.5, preferably from 1.5 to 14.0, particularly preferably from 2 to 10, very particularly preferably from 3 to 7. Here, the numbers mentioned always refer to a mean value. Here, “HLB according to Griffin” means the ratio of the hydrophilic and hydrophobic moieties of the molecule, expressed as the proportion of the ethylene oxide moiety with respect to the molecular weight of the entire molecule, multiplied by twenty.

Polyether compounds whose polyether groups also contain, in addition to the repeat units derived from ethylene oxide, other repeat units, i.e. repeat units derived from C₃-C₅-alkylene oxides and/or styrene oxide, generally have a modified HLB in the range of from 5 to 19.5, preferably from 5 to 16, particularly preferably from 7 to 14, very particularly preferably from 10 to 14; here, the numbers mentioned always refer to a mean value. Here, “modified HLB” means the ratio of the hydrophilic and hydrophobic moieties of the molecule, to take into account the different hydrophilicity of ethylene oxide units and other repeat units in the polyether chain, expressed as the proportion of the ethylene oxide moiety with respect to the molecular weight of the entire molecule, multiplied by twenty, plus the proportion of the other repeat units with respect to the molecular weight of the entire molecule, multiplied by ten.

The molecular weight of the polyether compounds may vary over wide ranges and is typically in the range of from 200 to 10 000 Dalton and in particular in the range of from 300 to 5000 Dalton (in each case number average), unless indicated otherwise. Preferably, the quotient of mass average and number average of the molecular weight is in the range of from 0.9 to 1.6, preferably in the range of from 1.0 to 1.4 and particularly preferably in the range of from 1.1 to 1.3.

The polyether groups in the polyether compounds S can generally be described by the general formula III

R^{x}—[(EO)ₓ(AO)_{y}]— (III)

in which
EO is —CH₂—CH₂—O—;
AO is —CHR^{a}—CR^{b}R^{c}—O—, with any arrangement of EO units and AO units within the chain being possible, including a random arrangement or a block arrangement;
R^{x} is hydrogen, C₁-C₁₀-alkyl, C₅-C₁₀-cycloalkyl, benzyl or C₁-C₂₀-alkylcarbonyl and is attached via the oxygen atom of an EO group or an AO group;
x is an integer whose number average is in the range of from 1 to 150, in particular from 2 to 80 and particularly preferably from 3 to 40;
y is an integer whose number average is in the range of from 0 to 150, in particular from 0 to 50 and especially from 0 to 30, where the number average of the sum of x and y is generally in the range of from 2 to 150, in particular in the range of from 3 to 80 and particularly preferably in the range of from 5 to 40;
R^{a}, R^{b} independently of one another are hydrogen or methyl and in particular hydrogen; and
R^{c} is hydrogen, C₁-C₄-alkyl, especially methyl or phenyl,
   where at least one of the radicals R^{a}, R^{b} and R^{c} is different from hydrogen.

In formula III, AO and EO are repeat units (monomer units) from which the polyether group is constructed. If the polyether groups of formula III comprise repeat units AO, the repeat units EO and AO may be in any arrangement, for example in a block arrangement where relatively long sequences of EO units are linked to relatively long sequences of AO units, or in a random arrangement, or in mixed forms of random arrangement and block arrangement. If the polyether groups III have a block arrangement of AO blocks and EO blocks, it is preferred for the polyether group to consist of 2 or 3 and in particular 2 blocks. Here, the indices x and y indicate the number of the respective repeat units within the polyether group. Since the polyether compounds are generally not molecularly uniform compounds but mixtures of compounds having various polyether chains which typically differ in the number of the respective repeat units, x and y are typically mean values (number average), in each case based on the total amount of repeat units EO and AO, respectively, in the polyether compound.

Groups AO which may be mentioned are, for example, radicals derived from propylene oxide (PO; R^{a}=R^{b}=hydrogen and R^{c}=methyl), butylene oxide (BO; R^{a}=R^{b}=hydrogen and R^{c}=ethyl), isobutylene oxide (IBO; R^{a}=hydrogen and R^{b}==methyl), pentylene oxide (PPO; R^{a}=R^{b}=hydrogen and R^{c}=propyl), hexylene oxide (HO; R^{a}=R^{b}=hydrogen and R^{c}=butyl) and styrene oxide (StO; R^{a}=R^{b}=hydrogen and R^{c}=phenyl). If the polyether group has radicals AO, these are preferably derived from propylene oxide.

From among the polyether compounds, preference is given to those having one or more groups of the formula III in which R^{x} is hydrogen or C₁-C₁₀-alkyl, in particular hydrogen or C₁-C₄-alkyl, especially methyl. In a preferred embodiment of the invention, the polyether groups are terminally modified, i.e. R^{x} is a radical different from hydrogen. In this case, R^{x} is preferably C₁-C₁₀-alkyl, in particular C₁-C₄-alkyl and especially methyl. Suitable as substance S are in particular also polyether compounds in which R^{x} is C₁-C₂₀-alkylcarbonyl. According to a particularly preferred embodiment, the polyether compounds are not terminally modified, i.e. R^{x} is hydrogen.

In a preferred embodiment, the polyether compound is selected from ethylene oxide/propylene oxide copolymers (hereinbelow referred to as EO/PO copolymers). These are to be understood as meaning polyether compounds predominantly, i.e. to at least 90% by weight, constructed of repeat units EO and PO (═CH₂—CH(CH₃)—O). Formally, these are compounds in which two polyether groups of the formula III in which y≠0 and AO is CH₂—CH(CH₃)O are attached to one another via an ether oxygen atom or via a C₄-C₁₀-alkanediyl group. From among these, preference is given to ethylene oxide/propylene oxide block copolymers in which the number of the PO blocks and the EO blocks is preferably 2 or in particular 3. Especially preferred are triblock copolymers of the formulae below

R^{x}[EOₓ₁][PO_{y3}][EOₓ₂]OR^{x′}

R^{x}[EOₓ₁][PO_{y1}]Y-A-Y[PO_{y2}][EOₓ₂]R^{x′}

R^{x}[PO_{y1}][EOₓ₃][PO_{y2}]OR^{x′}

Here, the unit [PO_{y1}]A[PO_{y2}] is seen as a PO block. In the formulae, R^{x}, EO, PO, x and y have the meanings mentioned above, and R^{x′} has one of the meanings given for R^{x}. Independently of one another, the indices x1 and x2 have one of the values given for x. The indices y1 and y2 are different from 0 and, besides, independently of one another have one of the values given for y. The index y3 typically denotes a value of from 2 to 160, in particular a value of from 4 to 100 and especially from 10 to 80. The index x3 typically denotes a value of from 4 to 200, in particular a value of from 10 to 100 and especially of from 10 to 80. A is C₄-C₁₀-alkanediyl or C₅-C₁₀-cycloalkanediyl. Y is oxygen or a radical NR in which R is hydrogen, C₁-C₄-alkyl or a group of the formula III. R^{x} and R^{x′} are in particular hydrogen or C₁-C₁₀-alkyl. The number average molecular weight of the EO/PO copolymers is preferably in the range of from 300 to 10 000 Dalton, in particular in the range of from 500 to 5000 Dalton. The percentage of EO repeat units is typically in the range of from 10 to 90% by weight, in particular in the range of from 20 to 80% by weight, and the percentage of the PO repeat units is in the range of from 10 to 90% by weight, in particular in the range of from 20 to 80% by weight, in each case based on the total weight of the EO/PO copolymer.

According to a further preferred embodiment of the invention, the polyether compound is selected from polyether compounds having at least one, for example 1, 2, 3 or 4, in particular 1 or 2, and especially one, polyether group of the formula III which is (are) attached covalently via an oxygen, sulfur or nitrogen atom to a hydrocarbon radical having 8 to 40 carbon atoms, in particular 10 to 30 carbon atoms and which optionally also has 1 or 2 carbonyloxy groups and/or 1, 2, 3 or 4 OH groups.

Preferred polyether compounds of this embodiment are:
polyethoxylates and poly(ethoxylate-co-propoxylate)s of C₈-C₂₂-alkanols, in particular C₁₀-C₁₈-alkanols. These are to be understood as meaning compounds having a group of the formula III which is attached via an oxygen atom to a C₈-C₂₂-alkyl radical, the group of the formula III having either exclusively EO repeat units or EO and PO repeat units;
polyethoxylates and poly(ethoxylate-co-propoxylate)s of fatty acids. These are to be understood as meaning compounds having a group of the formula III which is attached via an oxygen atom to a fatty acid radical, generally a C₈-C₂₂-alkylcarbonyl radical or a C₈-C₂₂-alkenylcarbonyl radical, the group of the formula III having either exclusively EO repeat units or EO and PO repeat units;
polyethoxylates and poly(ethoxylate-co-propoxylate)s of fatty amines. These are to be understood as meaning compounds having one or two groups of the formula III which are attached via a nitrogen atom to a hydrocarbon radical derived from a fatty amine, generally a C₈-C₂₂-alkyl radical, the group of the formula III having either exclusively EO repeat units or EO and PO repeat units;
polyethoxylates and poly(ethoxylate-co-propoxylate)s of mono- and diglycerides of aliphatic C₈-C₂₂-monocarboxylic acids. These are to be understood as meaning compounds having one or two groups of the formula III which are attached via an oxygen atom to a radical derived from a mono- or diglyceride of a saturated or unsaturated aliphatic C₈-C₂₂-monocarboxylic acid, the group of the formula III having either exclusively EO repeat units or EO and PO repeat units;
polyethoxylates and poly(ethoxylate-co-propoxylate)s of sorbitan esters of saturated or unsaturated aliphatic C₈-C₂₂-monocarboxylic acids. These are to be understood as meaning compounds having one or two groups of the formula III which are attached via an oxygen atom to a radical derived from a sorbitan mono- or diester of an aliphatic C₈-C₂₂-monocarboxylic acid, the group of the formula III having either exclusively EO repeat units or EO and PO repeat units;
polyethoxylates and poly(ethoxylate-co-propoxylate)s of alkylphenols. These are to be understood as meaning compounds having a group of the formula III which is attached via an oxygen atom to an alkylphenyl radical, in particular a mono- or di-C₄-C₂₀-alkylphenyl radical, the group of the formula III having either exclusively EO repeat units or EO and PO repeat units;
polyethoxylates and poly(ethoxylate-co-propoxylate)s of mono-, di- and tri-styrylphenols. These are to be understood as meaning compounds having a group of the formula III which is attached via an oxygen atom to a mono-, di- or tristyrylphenyl radical, the group of the formula III having either exclusively EO repeat units or EO and PO repeat units;
polyethoxylates and poly(ethoxylate-co-propoxylate)s of alkyl(poly)glycosides and mixtures thereof. These are to be understood as meaning compounds having one or more, for example 1, 2, 3 or 4, groups of the formula III which are attached via an oxygen atom to a radical derived from an alkyl(poly)glycoside, the group of the formula III having either exclusively EO repeat units or EO and PO repeat units.

Polyethoxylates and poly(ethoxylate-co-propoxylate)s of oligo- and polyalkyleneimines, in particular those of the compounds of the formula NH₂-(A—NH)ₖ-A′-NH₂ in which A and A′ independently of one another are ethane-1,2-diyl or propane-1,3-diyl and k is in the range of from 1 to 100 are also suitable, in addition to the polyether compounds mentioned above.

The polyethoxylates and poly(ethoxylate-co-propoxylate)s mentioned above may be terminally capped, i.e. the radical R^{x} is different from hydrogen and is in particular C₁-C₁₀-alkyl, preferably C₁-C₄-alkyl and especially methyl. Preference is also given to those of the above-mentioned polyethoxylates and poly(ethoxylate-co-propoxylate)s in which the radical R^{x} is hydrogen.

The number average molecular weight of the abovementioned polyethoxylates and poly(ethoxylate-co-propoxylate)s is preferably in the range of from 200 to 5000 Dalton, in particular in the range of from 300 to 3000 Dalton. The percentage of EO repeat units is typically in the range of from 7 to 98% by weight, in particular in the range of from 10 to 80% by weight and especially from 15 to 70% by weight, based on the total weight of the polyethoxylates and poly(ethoxylate-co-propoxylate)s. The PO and EO repeat units in the poly(ethoxylate-co-propoxylate)s may be arranged at random or in blockwise fashion, the latter being preferred. In particular, the poly(ethoxylate-co-propoxylate)s have a block of EO repeat units attached to the basic moiety of the compound and a block of PO repeat units which carries the radical R^{x}. From among these, particular preference is given to those polyethoxylates having a mean degree of ethoxylation (corresponding to the number average of x) in the range of from 3 to 50, in particular from 4 to 30 and especially from 5 to 20. From among the poly(ethoxylate-co-propoxylate)s, preference is given to those having a mean degree of ethoxylation in the range of from 2 to 49, preferably in the range of from 3 to 29 and especially in the range of from 4 to 19, and a mean degree of propoxylation (corresponding to the number average of y) in the range of from 1 to 48, in particular in the range of from 1 to 27 and especially in the range of from 1 to 16, the total degree of alkoxylation (corresponding to the number average of the sum x+y) preferably being in the range of from 3 to 50, especially from 4 to 30 and very particularly preferably in the range of from 5 to 20.

According to a particularly preferred embodiment, the polyether compound is a polyalkoxylated C₈-C₃₀-alkanol. Such compounds can be described by the general formula IV

R¹¹—O—[EOₓ;AO_{y}]—R^{x} (IV)

in which EO, AO, x, y, and R^{x} have the meanings mentioned above and R¹¹ is a straight-chain or branched alkyl radical having 8 to 30 carbon atoms, in particular 8 to 22 carbon atoms and especially 10 to 18 carbon atoms. Preferred straight-chain alkyl radicals R¹¹ are derived from alkanols having 8 to 22 carbon atoms, in particular 10 to 18 carbon atoms. Particularly preferred alkyl radicals R¹¹ are branched at least once and have 8 to 22 carbon atoms, in particular 10 to 18 carbon atoms. Examples of R¹¹ are straight-chain radicals, such as n-octyl, n-decyl, n-dodecyl, n-tridecyl, n-tetradecyl, n-pentadecyl, n-hexadecyl, n-octadecyl, and branched radicals, such as isononyl, isoundecyl, isotridecyl, isopentadecyl, 2-ethylhexyl and 2-propylheptyl. Here, it has to be kept in mind that in the compounds IV the radicals R¹¹ may also be mixtures of different radicals having preferably the same or a similar number of carbons and different degrees of branching, as obtained in the industrial preparation of the alkanols on which the compounds IV are based.

From among the polyether compounds of the formula IV, preference is given to those in which AO, if present, is CH₂CH(CH₃). From among these, particular preference is given to those compounds in which x is a number whose number average is in the range of from 2 to 49, preferably in the range of from 3 to 39 and especially in the range of from 4 to 29, y is a number whose number average is in the range of from 1 to 48, in particular in the range of from 1 to 37 and especially in the range of from 1 to 26, and the number average of the sum x+y is in the range of from 3 to 50, especially in the range of from 4 to 40. In particularly preferred poly(ethoxylate-co-propoxylate)s of the formula IV, the EO units and the PO unit are arranged in the form of two blocks. The polyether compounds IV may be terminally capped, i.e. R^{x} is different from hydrogen and is preferably C₁-C₁₀-alkyl, in particular C₁-C₄-alkyl and especially methyl. R^{x} is in particular hydrogen.

According to a further particularly preferred embodiment, the polyether compound is a polyalkoxylated alkylphenol or a polyalkoxylated mono-, di- or tristyrylphenol. Such compounds can be described by the general formula V

R¹²—O—[EOₓ;AO_{y}]—R^{x} (V)

in which EO, AO, x, y, and R^{x} have the meanings mentioned above and R¹² is a phenyl radical which carries one or two straight-chain or branched alkyl radicals having generally 4 to 20 carbon atoms, in particular 6 to 16 carbon atoms, or 1, 2 or 3 radicals derived from styrene. Examples of alkyl radicals on phenyl include n-butyl, tert-butyl, n-hexyl, n-octyl, n-decyl, n-dodecyl, n-tetradecyl, n-hexadecyl, n-octadecyl, isononyl, undecyl, tridecyl, 2-ethylhexyl and 2-propylheptyl.

From among the polyether compounds of the formula V, preference is given to those in which R^{x} in formula III is C₁-C₁₀-alkyl and AO, if present, is CH₂CH(CH₃). From among these, particular preference is given to those compounds in which x is a number whose number average is in the range of from 2 to 49, preferably in the range of from 3 to 29 and especially in the range of from 4 to 19, y is a number whose number average is in the range of from 1 to 48, in particular in the range of from 1 to 27 and especially in the range of from 1 to 16, and the number average of the sum x+y is in the range of from 3 to 50, especially from 4 to 30 and very particularly preferably in the range of from 5 to 20. In particularly preferred poly(ethoxylate-co-propoxylate)s of the formula V, the EO units and the PO unit are arranged in the form of two blocks.

In a second preferred embodiment, the substance S comprises at least one alkylpolyglycoside. In this embodiment, the percentage of the alkylpolyglycoside in substance S is typically at least 90% by weight. In a further preferred embodiment, the substance S is a mixture of alkylpolyglycoside and at least one polyether compound, in particular a polyether compound of the formula IV or V. In this case, the weight ratio of alkylglycoside to polyether compound is typically in the range of from 9:1 to 1:9, in particular in the range of from 2:8 to 8:2.

The abovementioned substances S are known to the person skilled in the art and commercially available. Typical commercial products of the formula IV are available, for example, from BASF under the common trade name of the “Lutensols”, where, depending on the basic moiety, a distinction is made between Lutensols of series A, AO, AT, ON, AP, XP, XL, TO and FA. Further added numbers indicate the degree of ethoxylation. Thus, for example, “Lutensol AO 8” is a C₁₃₋₁₅-oxoalcohol having eight EO units. “Lutensol FA” is a group of alkoxylated amines.

Further examples of polyether compounds suitable according to the invention are products from Akzo, for example the “Ethylan” series based on straight-chain or branched alcohols. Thus, for example “Ethylan SN 120” is a C₁₀₋₁₂-alkohol having ten EO units, and “Ethylan 4 S” is a C₁₂₋₁₄-alcohol having four EO units.

Further examples of polyalkoxylates suitable according to the invention are furthermore the “NP” products from Akzo (previously Witco), which are based on nonylphenols.

Polyether compounds suitable according to the invention are also “narrow range” products. Here, the term “narrow range” refers to a relatively narrow distribution of the number of EO units. These include, for example, products of the “Berol” series from Akzo.

Furthermore according to the invention are sorbitan ester ethoxylates, for example “Armotan AL 69-66 POE(30) sorbitan monotallate”, i.e. unsaturated fatty acids esterified with sorbitol and then ethoxylated.

In a preferred embodiment of the invention, the aqueous active compound concentrate comprises components a) and b) in the form of their dissolved salts, in particular in the form of their dissolved alkali metal or ammonium salts, preferably in the form of their dissolved sodium, potassium or ammonium salts. The pH of the aqueous active compound concentrate is preferably at least pH 8.0 and is in particular in the range of pH 8.0 to 10.0, particularly preferably in the range of pH 8.0 to 9.0.

The present invention relates in particular to aqueous active compound concentrates of compounds of the formula I in which R¹ and R³ independently of one another are preferably halogen, methyl, methylthio, methylsulfinyl or methylsulfonyl. R² is in particular a radical selected from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the radicals mentioned above are unsubstituted or may be substituted in the manner mentioned above and are in particular unsubstituted or may carry 1 or 2 methyl groups as substituents. R² is in particular selected from the group consisting of isoxazol-5-yl, 3-methylisoxazol-5-yl, 4,5-dihydroisoxazol-3-yl, 5-methyl-4,5-dihydroisoxazol-3-yl, 5-ethyl-4,5-dihydroisoxazol-3-yl and 4,5-dimethyl-4,5-dihydroisoxazol-3-yl. R⁴ is in particular hydrogen. R⁵ is in particular methyl. R⁶ is in particular hydrogen or methyl. R¹ is in particular chlorine, methyl or methylsulfonyl R² is hydrogen or 4,5-dihydroisoxazol-3-yl, R³ is chlorine or methylsulfonyl, R⁴ is hydrogen, R⁵ is methyl and R⁶ is hydrogen or methyl.

In a particularly preferred embodiment of the invention, R¹ is methyl, R² is 4,5-dihydro-isoxazol-3-yl, R³ is methylsulfonyl, R⁴ is hydrogen, R⁵ is methyl and R⁶ is hydrogen, i.e. the component a) comprises 4-[2-methyl-3-(4,5-dihydroisoxazol-3-yl)-4-methylsulfonyl-benzoyl]-1-methyl-5-hydroxy-1H-pyrazole (common name: topramezone).

The present invention relates in particular to aqueous active compound concentrates of compounds of the formula II in which R⁷ is hydrogen or methoxy and R⁸ is hydrogen, chlorine or amino. R⁷ is in particular methoxy. In a particularly preferred compound of the formula II, R⁷ is methoxy and R⁸ is hydrogen. In another particularly preferred compound of the formula II, R⁷ is hydrogen and R⁸ is amino. It is most preferred for component b) to comprise 3,6-dichloro-ortho-anisic acid (common name: dicamba).

With utmost preference, the aqueous liquid formulation comprises, as component a), 4-[2-methyl-3-(4,5-dihydroisoxazol-3-yl)-4-methylsulfonyl-benzoyl]-1-methyl-5-hydroxy-1H-pyrazole in dissolved form and, as component b), 3,6-dichloro-ortho-anisic acid in dissolved form.

The concentration of 4-benzoyl-substituted pyrazole compounds of the formula I in the active compound concentrate according to the invention is generally from 10 to 100 g/l and in particular from 25 to 80 g/l. The concentration of benzoic acid compound of the formula II in the active compound concentrate according to the invention is generally from 50 to 250 g/l and in particular from 80 to 200 g/l and especially from 140 to 160 g/l. The total concentration of nonionic surfactant S in the aqueous active compound concentrates according to the invention is generally in the range of from 100 to 300 g/l, in particular in the range of from 200 to 400 g/l.

In a particular embodiment of the invention, the aqueous liquid formulation comprises a herbicidally active 4-benzoyl-substituted pyrazole compound of the formula I and a herbicidally active benzoic acid derivative of the formula II in a relative mass ratio (weight ratio) of from 1:25 to 2:1, preferably from 1:10 to 1:1 and particularly preferably from 1:5 to 1:3.

In a particular embodiment of the invention, the aqueous liquid formulation comprises an active compound mixture of a herbicidally active 4-benzoyl-substituted pyrazole compound of the formula I and a herbicidally active benzoic acid derivative of the formula II and also a nonionic surfactant S, the mass ratio (weight ratio) of the total amount of the active compound mixture to the amount of substance S being in the range of from 1:10 to 3:1, preferably from 1:3 to 3:2 and particularly preferably from 2:3 to 1:1.

At least some of the compounds comprising substance S are described in the prior art.

The aqueous active compound concentrates according to the invention may additionally also comprise further substances which are not directly relevant to the aim of the compositions, but which improve their applicability and/or practical properties. Examples of these are in particular
viscosity-regulating substances (thickeners),
preservatives,
antifoams,
agents for adjusting the pH,
antifreeze agents.

Such substances are familiar to the person skilled in the art. The total amount of such substances will generally not exceed 10% by weight, based on the active compound concentrate, and is typically in the range of from 0.1 to 10% by weight, based on the total weight of the active compound concentrate.

The viscosity-modifying additives (thickeners) include in particular compounds which are known to impart pseudoplastic flow behavior to aqueous formulations, i.e. high viscosity in the state of rest and low viscosity in the state of motion. Suitable are, in principle, all compounds used for this purpose in aqueous active compound concentrates. Mention may be made, for example, of inorganic substances, such as bentonite or attapulgite (for example Attaclay® from Engelhardt), and organic substances, such as polysaccharides and heteropolysaccharides, such as Xanthan Gum® (Kelzan® from Kelco), Rhodopol® 23 (Rhone Poulenc) or Veegum® (from R.T. Vanderbilt), with Xanthan-Gum® being preferred. The amount of viscosity-modifying additives is frequently from 0.1 to 5% by weight, based on the total weight of the active compound concentrate.

Suitable antifoams are, for example, silicone emulsions (Silikon® SRE, from Wacker, or Rhodorsil®, from Rhodia), long-chain alcohols, fatty acids, defoamers of the type of aqueous wax dispersions, solid defoamers (“compounds”), organofluorine compounds and mixtures thereof known to be suitable for this purpose. The amount of antifoam is typically from 0.1 to 1% by weight, based on the total weight of the active compound concentrate.

Examples of preservatives are those based on isothiazolones, for example Proxel® from ICI or Acticide® RS from Thor Chemie or Kathon® MK from Rohm & Haas. The amount of preservatives, if present, is typically from 0.05 to 0.5% by weight, based on the total weight of the active compound concentrate.

Suitable antifreeze agents are liquid alkanols, such as methanol, ethanol, isopropanol, n-butanol, polyols, for example ethylene glycol, propylene glycol or glycerol. The amount of antifreeze agents, if present, is generally from 1 to 10% by weight, based on the total weight of the active compound concentrate.

If appropriate, the active compound concentrates according to the invention may comprise agents for regulating the pH. Examples of such agents are bases, for example alkali metal hydroxides, such as potassium hydroxide, sodium hydroxide, sodium carbonate, potassium carbonate or ammonia, or else buffers, for example alkali metal salts of weak inorganic or organic acids, such as, for example phosphoric acid, boric acid, acetic acid, propionic acid, citric acid, furmaric acid, tartaric acid, oxalic acid and succinic acid. The amount of agents for adjusting the pH, if present, is generally from 0.01 to 3% by weight, based on the total weight of the active compound concentrate.

The aqueous active compound concentrates according to the invention can be prepared in a simple manner by dissolving the active compounds of the formulae I and II in water or in an aqueous medium and adding substance S and, if appropriate, the further ingredients of the active compound concentrate, if appropriate in dissolved form, to the resulting solution. Here and below, an aqueous medium is to be understood as meaning water which comprises part of the other components optionally present of the active compound concentrate, for example bases, buffers, preservatives, etc. Dissolution of the active compounds of the formulae I and II may be carried out jointly or successively in one apparatus or in separate apparatuses, where in the latter case the resulting aqueous solutions are combined. Frequently, for dissolving the active compounds, the active compound I is suspended in water and the pH is adjusted to pH>7, in particular pH≧8, for example to pH 8 to pH 10, in particular to pH 8 to pH 9, by addition of a base or a buffer, whereupon the active compound of the formula I goes into solution. The solution obtained in this manner is then mixed with an aqueous solution of the benzoic acid compound II or with an aqueous solution of a salt of the benzoic acid compound II, for example an alkali metal salt or an ammonium salt. Alternatively, it is also possible to suspend a mixture of active compound I and benzoic acid compound II or one of the abovementioned salts of the benzoic acid compound II in water and then adjust the pH of the suspension by addition of a base or a buffer to the range mentioned above, whereupon the active compounds of formulae and II go into solution. The other components of the active compound concentrate are then added to the solutions obtained in this manner, which are homogenized in a customary manner, for example by stirring, ultrasound.

The aqueous active compound concentrates obtained in this manner are particularly suitable for controlling a large number of unwanted plants. The active compound concentrates according to the invention are highly suitable for controlling unwanted vegetation on non-crop areas, in particular at high application rates. In cereal crops such as wheat, rye, barley, millet, oats or triticale, and also in corn, they act against broad-leaved weeds and weed grasses without causing any significant damage to the crop plants. This effect is observed especially at low application rates. The active compound concentrates according to the invention are particularly suitable for eliminating harmful plants in corn. Depending on the application method in question, the active compound concentrates according to the invention can also be employed in other crop plants for eliminating unwanted plants.

In addition, the active compound concentrates can also be used in crops which tolerate the action of herbicides owing to breeding, including genetic engineering methods.

The active compound concentrates are generally applied in the form of an aqueous spray liquor. To this end, the active compound concentrates according to the invention are, depending on the application rate, diluted with water to a multiple of their volume, for example 10- to 10 000-fold, in particular 20- to 1000-fold. The active compound concentration (total amount of active compound) in the spray liquor is then typically in the range of from 5 mg/l to 5 g/l, in particular from 0.01 to 1 g/l.

Application may be by the pre-emergence method, by the post-emergence method or together with the seed of a crop plant. It is also possible to apply the active compounds of the formulae I and II present in the active compound concentrates using the active compound concentrates according to the invention by treating seed of a crop plant with the active compounds of the formulae I and II and sowing the seed treated in this manner. If the active compounds are less well tolerated by certain crop plants, application techniques may be used in which the application forms prepared using the active compound concentrates are sprayed, with the aid of the spraying equipment, in such a way that as far as possible they do not come into contact with the leaves of the sensitive crop plants, while the active compounds reach the leaves of unwanted plants growing underneath, or the bare soil surface (post-directed, lay-by).

Based on the total amount of active compound I and II, the application rates are, depending on the control target, the season, the target plants and the growth stage, from 0.001 to 3.0, preferably 0.005 to 0.5 kg/ha.

To widen the activity spectrum and to achieve synergistic effects, the active compound concentrates may, prior to application, be mixed with numerous representatives of other herbicidal or growth-regulating groups of active compounds and then applied jointly, for example by the tank-mix method. Suitable components for mixtures are, for example, 1,2,4-thiadiazoles, 1,3,4-thiadiazoles, amides, aminophosphoric acid and derivatives thereof, aminotriazoles, anilides, (het)aryloxyalkanoic acid and derivatives thereof, benzoic acid and derivatives thereof, benzothiadiazinones, 2-aroyl-1,3-cyclohexanediones, 2-hetaroyl-1,3-cyclohexanediones, hetaryl aryl ketones, benzylisoxazolidinones, meta-CF₃-phenyl derivatives, carbamates, quinolinecarboxylic acid and derivatives thereof, chloroacetanilides, cyclohexenone oxime ether derivatives, diazines, dichloropropionic acid and derivatives thereof, dihydrobenzofurans, dihydrofuran-3-ones, dinitroanilines, dinitrophenols, diphenyl ethers, dipyridyls, halocarboxylic acids and derivatives thereof, ureas, 3-phenyluracils, imidazoles, imidazolinones, N-phenyl-3,4,5,6-tetrahydrophthalimides, oxadiazoles, oxiranes, phenols, aryloxy- or heteroaryloxyphenoxypropionic esters, phenylacetic acid and derivatives thereof, phenylpropionic acid and derivatives thereof, pyrazoles, phenylpyrazoles, pyridazines, pyridinecarboxylic acid and derivatives thereof, pyrimidyl ethers, sulfonamides, sulfonylureas, triazines, triazinones, triazolinones, triazolecarboxamides, uracils.

It may furthermore be beneficial to mix the active compound concentrates prior to application with other crop protection agents, followed by joint application, for example with agents for controlling pests or phytopathogenic fungi or bacteria. Also of interest is the miscibility with mineral salt solutions, which are employed for eliminating nutritional and trace element deficiencies. It is also possible to add nonphytotoxic oils and oil concentrates.

### A PREPARATION EXAMPLES

### Examples 1 to 11

### Preparation of an Active Compound Concentrate According to the Invention (General Procedure)

50 g of topramezone (active compound of the general formula I in which R¹ and R⁵ are methyl, R² is 4,5-dihydrooxazol-3-yl, R³ is methylsulfonyl, R⁴ and R⁶ are hydrogen) and 160 g of dicamba (active compound of the formula II in which R⁷ is methoxy and R⁸ is hydrogen) were suspended in 300 ml of water. By addition of 40% by weight strength aqueous potassium hydroxide solution, the pH of the suspension was adjusted to pH 8.5, 300 g of the substance S in question, if appropriate, in the form of an aqueous mixture, and water ad 1 l were added to the resulting solution and the mixture was homogenized with stirring for 2 h. This gave a clear solution comprising 50 g of topramezone/l, 160 g of dicamba/l and 300 g of the substance S in question.

The following substances S were used:

S1: EO/PO triblock copolymer having OH end groups, a molecular weight of 3100 Dalton (number average) and an EO percentage of 42% by weight

S2: 2-ethylhexylpolyglucoside having 1.6-glucose units

S3: polyethoxylate of the formula CH₃—O—(C₂H₄—O)₁₁—NH₂

S4: ethoxylated polyimine having a degree of ethoxylation of 7 EO groups per nitrogen atom, a molecular weight of about 14 000 (number average) and a percentage by weight of EO groups of about 82% by weight

S5: ethoxylate-co-propoxylate of the formula R—O-(EO)ₓ(PO)_{y}H in which EO and PO have the meanings mentioned above, R is straight-chain C₁₃-C₁₅-alkyl, y is 23 and x is 10

S6: ethoxylate of the formula R—O-(EO)ₓH in which EO has the meanings mentioned above, R is branched C₁₋₁₀-alkyl and x is 7 (Lutensol ON 70)

S7: ethoxylate-co-propoxylate of the formula R—O—[(PO)_{y}(EO)ₓ]H in which EO and PO are arranged randomly and have the meanings mentioned above, R is straight-chain C₉-C₁₁-alkyl, y is 2 and x is 7.5

S8: ethoxylate-co-propoxylate of the formula R—O-(EO)ₓ(PO)_{y}H in which EO and PO have the meanings mentioned above, R is branched C₁₃-alkyl, y is 3 and x is 6

S9: ethoxylate of the formula R—O-(EO)ₓH in which EO has the meanings mentioned above, R is branched C₁₃-alkyl and x is 5 (Lutensol TO 5)

S10: ethoxylate of the formula R—O-(EO)ₓH in which EO has the meanings mentioned above, R is branched C₁₀-alkyl and x is 3 (Lutensol ON 30)

S11: ethoxylate of the formula R—O-(EO)ₓH in which EO has the meanings mentioned above, R is branched C₁₀-alkyl and x is 5 (Lutensol ON 50).

### B EXAMINATION OF THE APPLICATION PROPERTIES

After 2 weeks of storage at 54° C., the active compound concentrates according to the invention showed no visible changes.

The foaming tendencies were determined according to Ross-Miles (ASTM-D 1173 53). It was low, in particular with the preparation formulated using S5.

### C EXAMINATION OF THE HERBICIDAL ACTION

### 1. Herbicidal Action Against Harmful Grasses

The herbicidal action of the active compound concentrates according to the invention against graminaceous harmful plants was demonstrated by the following greenhouse tests:

The culture containers used were plastic pots containing loamy sand with approximately 3.0% of humus as the substrate. The seeds of the test plants were sown separately for each species.

For the pre-emergence treatment, the active compound concentrates, which were diluted with water to the desired application concentration, were applied directly after sowing by means of finely distributing nozzles at the stated application rate. The containers were irrigated gently to promote germination and growth and subsequently covered with transparent plastic hoods until the plants had rooted. This cover causes uniform germination of the test plants, unless this has been impaired by the active compounds.

For the post-emergence treatment, the test plants were first grown to a height of 3 to 15 cm, depending on the plant habit, and then treated with the active compound concentrates diluted with water to the desired application concentration (about 66 to 525 mg of active compound/l). For this purpose, the test plants were either sown directly and grown in the same containers, or they were first grown separately as seedlings and transplanted into the test containers a few days prior to treatment.

Depending on the species, the plants were kept at temperatures of 10-25° C. or 20-35° C. The test period extended over 2 to 4 weeks. During this time, the plants were tended, and their response to the individual treatments was evaluated.

Evaluation was carried out using a scale from 0 to 100. 100 means no emergence of the plants, or complete destruction of at least the above-ground parts, and 0 means no damage, or normal course of growth.

The harmful plants (weeds) examined were grasses of the following species: Digitaria sanguinalis (DIGSA), Echinochloa crus-galli (ECHCG), Panicum sp. (PANMI), Panicum milliaceum (PANMI), Setaria faberi (SETFA), Setaria italica (SETIT), Setaria lutescens (SETLU), Setaria viridis (SETVI).

Table 1 shows the results obtained for the post-emergence treatment (damage 20 or 21 days after treatment).

TABLE 1

| | | Harmful plant | | | | | | | | |
|---|---|---|---|---|---|---|---|---|---|---|
| Substance S | Dosage | DIGSA | ECHCG | PANDI | SETVA | PANMI | SETIT | SETLU | SETVI | ø |
| S1 | A | 100 | 85 | 70 | 100 | 100 | 100 | 100 | 100 | 94 |
| | B | 90 | 30 | 30 | 100 | 100 | 98 | 85 | 100 | 79 |
| | C | 75 | 0 | 20 | 98 | 95 | 95 | 85 | 80 | 69 |
| | D | 20 | 0 | 0 | 75 | 80 | 30 | 40 | 30 | 29 |
| S2 | A | 95 | 50 | 65 | 100 | 100 | 100 | 100 | 100 | 89 |
| | B | 50 | 20 | 30 | 100 | 98 | 98 | 95 | 100 | 74 |
| | C | 0 | 0 | 0 | 90 | 90 | 85 | 65 | 85 | 52 |
| | D | 0 | 0 | 0 | 50 | 85 | 30 | 40 | 30 | 29 |
| S3 | A | 95 | 30 | 75 | 100 | 98 | 100 | 95 | 98 | 86 |
| | B | 65 | 0 | 30 | 98 | 95 | 98 | 50 | 95 | 66 |
| | C | 10 | 0 | 0 | 85 | 90 | 90 | 30 | 80 | 48 |
| | D | 0 | 0 | 0 | 65 | 80 | 30 | 0 | 30 | 26 |
| S4 | A | 90 | 50 | 70 | 100 | 95 | 100 | 95 | 100 | 88 |
| | B | 60 | 20 | 40 | 98 | 95 | 98 | 90 | 100 | 75 |
| | C | 30 | 0 | 0 | 98 | 90 | 40 | 65 | 85 | 51 |
| | D | 0 | 0 | 0 | 50 | 75 | 20 | 30 | 40 | 27 |
| S5 | A | 100 | 95 | 75 | 100 | 100 | 100 | 100 | 100 | 96 |
| | B | 95 | 70 | 40 | 98 | 100 | 100 | 90 | 98 | 86 |
| | C | 50 | 30 | 20 | 98 | 90 | 90 | 85 | 40 | 63 |
| | D | 20 | 0 | 0 | 60 | 80 | 30 | 50 | 20 | 33 |
| S6 | A | 100 | 90 | 70 | 100 | 100 | 100 | 100 | 100 | 95 |
| | B | 90 | 75 | 30 | 98 | 98 | 100 | 95 | 100 | 86 |
| | C | 40 | 30 | 0 | 98 | 95 | 75 | 70 | 90 | 62 |
| | D | 0 | 0 | 0 | 90 | 80 | 30 | 40 | 40 | 35 |
| S6 | A | 98 | 98 | 25 | 100 | 98 | 98 | 98 | 98 | 86 |
| | B | 85 | 25 | 20 | 98 | 95 | 95 | 85 | 95 | 67 |
| | C | 75 | 10 | 0 | 98 | 70 | 50 | 10 | 70 | 48 |
| | D | 40 | 0 | 0 | 35 | 40 | 40 | 10 | 30 | 23 |
| S7 | A | 95 | 98 | 70 | 100 | 98 | 100 | 100 | 98 | 89 |
| | B | 90 | 40 | 10 | 98 | 95 | 85 | 95 | 95 | 67 |
| | C | 45 | 0 | 0 | 90 | 70 | 60 | 30 | 60 | 41 |
| | D | 40 | 0 | 0 | 35 | 40 | 40 | 10 | 30 | 23 |
| S8 | A | 98 | 85 | 15 | 100 | 98 | 98 | 98 | 98 | 80 |
| | B | 85 | 12 | 10 | 90 | 80 | 90 | 80 | 98 | 64 |
| | C | 65 | 0 | 5 | 0 | 20 | 70 | 10 | 15 | 22 |
| | D | 20 | 0 | 0 | 0 | 20 | 25 | 10 | 15 | 11 |
| S9 | A | 98 | 30 | 65 | 98 | 90 | 45 | 85 | 95 | 76 |
| | B | 90 | 10 | 20 | 100 | 75 | 70 | 70 | 30 | 37 |
| | C | 50 | 0 | 0 | 75 | 65 | 55 | 15 | 40 | 34 |
| | D | 45 | 0 | 0 | 40 | 40 | 30 | 10 | 25 | 22 |
| S10 | A | 98 | 80 | 75 | 98 | 98 | 90 | 98 | 98 | 84 |
| | B | 80 | 20 | 10 | 98 | 85 | 85 | 80 | 98 | 63 |
| | C | 25 | 0 | 5 | 90 | 45 | 40 | 25 | 70 | 33 |
| | D | 20 | 0 | 0 | 40 | 30 | 30 | 10 | 25 | 17 |
| S11 | A | 98 | 95 | 70 | 98 | 98 | 90 | 98 | 98 | 89 |
| | B | 90 | 20 | 10 | 95 | 85 | 90 | 65 | 90 | 70 |
| | C | 60 | 0 | 0 | 80 | 60 | 70 | 40 | 35 | 39 |
| | D | 20 | 0 | 0 | 30 | 40 | 40 | 20 | 25 | 19 |
| none | A′ | 80 | 15 | 10 | 90 | 80 | 85 | 80 | 90 | 60 |
| | B′ | 20 | 0 | 5 | 70 | 70 | 70 | 50 | 70 | 40 |
| | C′ | 15 | 0 | 5 | 70 | 60 | 60 | 20 | 65 | 34 |
| | D′ | 15 | 0 | 0 | 30 | 40 | 40 | 10 | 20 | 18 |

A: 25 g of topramezone/ha, 80 g of dicamba/ha, 150 g of substance S/ha
B: 12.5 g of topramezone/ha, 40 g of dicamba/ha, 75 g of substance S/ha
C: 6.25 g of topramezone/ha, 20 g of dicamba/ha, 37.5 g of substance S/ha
D: 3.13 g of topramezone/ha, 10 g of dicamba/ha, 18.8 g of substance S/ha
A′: 25 g of topramezone/ha, 80 g of dicamba/ha,
B′: 12.5 g of topramezone/ha, 40 g of dicamba/ha,
C′: 6.25 g of topramezone/ha, 20 g of dicamba/ha,
D′: 3.13 g of topramezone/ha, 10 g of dicamba/ha,

At the same application rate, the herbicidal activity of concentrates formulated according to the invention against gramineous harmful plants exceeds the activity of a concentrate without added surfactants considerably. In particular in the case of Setaria species, complete control was possible.

### 2. Herbicidal Action Against Non-Gramineous Harmful Plants

Analogously to 1., the efficacy of formulations according to the invention against the non-gramineous harmful plants Avena fatua, Sorghum bicolor was examined.

Table 2 shows the results obtained for the post-emergence treatment (examined 20 or 21 days after treatment).

TABLE 2

| | |
|---|---|
| Substance S | Target plant |

| (class) | Dosage | Avena fatua | Sorghum bicolor |
|---|---|---|---|
| S1 | A | 50 | 50 |
| | B | 40 | 40 |
| | C | 30 | 30 |
| | D | 20 | 20 |
| S2 | A | 40 | 20 |
| | B | 30 | 0 |
| | C | 20 | 0 |
| | D | 10 | 0 |
| S3 | A | 50 | 30 |
| | B | 30 | 20 |
| | C | 20 | 0 |
| | D | 10 | 0 |
| S4 | A | 50 | 25 |
| | B | 30 | 0 |
| | C | 20 | 0 |
| | D | 10 | 0 |
| S5 | A | 40 | 75 |
| | B | 30 | 30 |
| | C | 20 | 0 |
| | D | 10 | 0 |
| S6 | A | 40 | 25 |
| | B | 30 | 20 |
| | C | 10 | 0 |
| | D | 0 | 0 |
| S7 | A | 40 | 70 |
| | B | 5 | 10 |
| | C | 15 | 0 |
| | D | 5 | 0 |
| S8 | A | 30 | 15 |
| | B | 25 | 10 |
| | C | 10 | 5 |
| | D | 5 | 0 |
| S9 | A | 30 | 65 |
| | B | 15 | 20 |
| | C | 10 | 0 |
| | D | 5 | 0 |
| S10 | A | 20 | 75 |
| | B | 10 | 10 |
| | C | 0 | 5 |
| | D | 0 | 0 |
| S11 | A | 60 | 70 |
| | B | 85 | 10 |
| | C | 5 | 0 |
| | D | 0 | 0 |
| none | A′ | 70 | 10 |
| | B′ | 10 | 5 |
| | C′ | 10 | 5 |
| | D′ | 5 | 0 |

A: 25 g of topramezone/ha, 80 g of dicamba/ha, 150 g of substance S/ha, or A′: 25 g of topramezone/ha, 80 g of dicamba/ha,
B: 12.5 g of topramezone/ha, 40 g of dicamba/ha, 75 g of substance S/ha, or B: 12.5 g of topramezone/ha, 40 g of dicamba/ha
C: 6.25 g of topramezone/ha, 20 g of dicamba/ha, 37.5 g of substance S/ha, or C: 6.25 g of topramezone/ha, 20 g of dicamba/ha
D: 3.13 g of topramezone/ha, 10 g of dicamba/ha, 18.8 g of substance S/ha, or D: 3.13 g of topramezone/ha, 10 g of dicamba/ha

### 3. Herbicidal Action Against Useful Plants

Analogously to 1., the efficacy of active compound concentrates according to the invention against the useful plants Zea mays (ZEAMX) of the cultivars “Dea” and “Helix” was examined.

The plants were treated by the post-emergence method. The damage to the plants was determined on day 6 or 8 (measurement A) and on day 20 or 21 (measurement B) after the treatment. Otherwise, the procedure of Example 1 was adopted.

Table 3 shows the results obtained for the post-emergence treatment.

TABLE 3

| | Target plants and day | |
|---|---|---|
| | ZEAMX | ZEAMX |
| Dosage | “Dea” | “Helix” |

| Substance S | [Ml/ha] | A | B | A | B |
|---|---|---|---|---|---|
| S1 | A | 5 | 15 | 5 | 0 |
| | B | 5 | 0 | 5 | 0 |
| | C | 0 | 0 | 5 | 0 |
| | D | 0 | 0 | 0 | 0 |
| S2 | A | 5 | 0 | 5 | 0 |
| | B | 0 | 0 | 5 | 0 |
| | C | 0 | 0 | 0 | 0 |
| | D | 0 | 0 | 0 | 0 |
| S3 | A | 5 | 0 | 5 | 0 |
| | B | 5 | 0 | 5 | 0 |
| | C | 0 | 0 | 0 | 0 |
| | D | 0 | 0 | 0 | 0 |
| S4 | A | 5 | 0 | 5 | 0 |
| | B | 0 | 0 | 5 | 0 |
| | C | 0 | 0 | 0 | 0 |
| | D | 0 | 0 | 0 | 0 |
| S5 | A | 5 | 5 | 0 | 5 |
| | B | 5 | 0 | 0 | 0 |
| | C | 5 | 0 | 0 | 0 |
| | D | 0 | 0 | 0 | 0 |
| S6 | A | 0 | 0 | 0 | 5 |
| | B | 0 | 0 | 0 | 0 |
| | C | 0 | 0 | 0 | 0 |
| | D | 0 | 0 | 0 | 0 |
| S7 | A | 0 | 0 | 0 | 0 |
| | B | 0 | 0 | 0 | 0 |
| | C | 0 | 0 | 0 | 0 |
| | D | 0 | 0 | 0 | 0 |
| S8 | A | 5 | 0 | 5 | 0 |
| | B | 0 | 0 | 0 | 0 |
| | C | 0 | 0 | 0 | 0 |
| | D | 0 | 0 | 0 | 0 |
| S9 | A | 0 | 5 | 0 | 0 |
| | B | 0 | 0 | 0 | 0 |
| | C | 0 | 0 | 0 | 0 |
| | D | 0 | 0 | 0 | 0 |
| S10 | A | 0 | 0 | 5 | 0 |
| | B | 0 | 0 | 0 | 0 |
| | C | 0 | 0 | 0 | 0 |
| | D | 0 | 0 | 0 | 0 |
| S11 | A | 0 | 0 | 5 | 0 |
| | B | 0 | 0 | 0 | 0 |
| | C | 0 | 0 | 0 | 0 |
| | D | 0 | 0 | 0 | 0 |
| no substance S | A′ | 0 | 0 | 0 | 0 |
| | B′ | 0 | 0 | 0 | 0 |
| | C′ | 0 | 0 | 0 | 0 |
| | D′ | 0 | 0 | 0 | 0 |

1-16. (canceled)

17. An aqueous active compound concentrate comprising, in dissolved form:
a) at least one 4-benzoyl-substituted pyrazole compound of the formula I 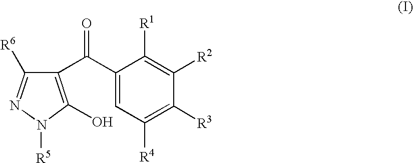
in which
R¹ and R³ independently of one another are hydrogen, halogen, methyl, halomethyl, methoxy, halomethoxy, methylthio, methylsulfinyl or methylsulfonyl;
R² is a 5-membered heterocyclic radical which is unsubstituted or carries 1, 2, 3 or 4 substituents selected from the group consisting of halogen, C₁-C₆-alkyl, C₁-C₄-alkoxy, C₁-C₄-haloalkyl, C₁-C₄-haloalkoxy and C₁-C₄-alkylthio;
R⁴ is hydrogen, halogen or methyl;
R⁵ is C₁-C₆-alkyl, C₃-C₆-cycloalkyl or C₃-C₆-cycloalkylmethyl; and
R⁶ is hydrogen or C₁-C₄-alkyl;
or one of its salts;
b) at least one benzoic acid compound of the formula II 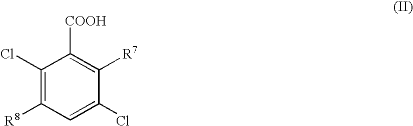
in which
R⁷ is hydrogen, halogen, hydroxyl or methoxy and
R⁸ is hydrogen, halogen or amino;
or one of its salts; and
c) at least one nonionic surfactant S, selected from polyether compounds having repeat units derived from ethylene oxide, alkylpolyglycosides and mixtures thereof
in which the weight ratio of the total amount of active compound of pyrazole compound of the formula I and benzoic acid compound of the formula II to surfactant S is in the range of from 1:10 to 3:1,
where the polyether compound has at least one polyether group of the formula III
R^{x}—[(EO)ₓ(AO)_{y}]— (III)
in which
EO is —CH₂—CH₂—O—;
AO is —CHR^{a}—CR^{b}R^{c}—O—;
R^{x} is hydrogen, C₁-C₁₀-alkyl, C₅-C₁₀-cycloalkyl, benzoyl or C₁-C₂₀-alkylcarbonyl and is attached via the oxygen atom of an EO group or an AO group;
x is an integer whose number average is in the range of from 1 to 150;
y is an integer whose number average is in the range of from 0 to 150, the number average of the sum of x and y being in the range of from 5 to 150;
R^{a} and R^{b} independently of one another are hydrogen or methyl; and
R^{c} is hydrogen, C₁-C₄-alkyl or phenyl
where at least one of the radicals R^{a}, R^{b} and R^{c} is different from hydrogen, and where the polyether compound is selected from
ethylene oxide/propylene oxide copolymers,
polyether compounds in which the at least one polyether group of the formula III is attached covalently via an oxygen, sulfur or nitrogen atom to a hydrocarbon radical having 8 to 40 carbon atoms, and which optionally also has 1 or 2 carbonyloxy groups and/or 1, 2, 3 or 4 OH groups,
and mixtures thereof.

18. The active compound concentrate according to claim 17, wherein the nonionic surfactant S has an HLB according to Griffin in the range of from 1.5 to 19.5.

19. The active compound concentrate according to claim 17, wherein the nonionic surfactant S has a modified HLB in the range of from 5 to 19.5.

20. The active compound concentrate according to claim 17, wherein the polyether compound is
a) polyethoxylates and poly(ethoxylate-co-propoxylate)s of C₉-C₂₂-alkanols,
b) polyethoxylates and poly(ethoxylate-co-propoxylate)s of fatty acids,
c) polyethoxylates and poly(ethoxylate-co-propoxylate)s of fatty amines,
d) polyethoxylates and poly(ethoxylate-co-propoxylate)s of mono- and diglycerides of aliphatic C₈-C₂₂-monocarboxylic acids,
e) polyethoxylates and poly(ethoxylate-co-propoxylate)s of sorbitan esters of aliphatic C₈-C₂₂-monocarboxylic acids,
f) polyethoxylates and poly(ethoxylate-co-propoxylate)s of alkylphenols,
g) polyethoxylates and poly(ethoxylate-co-propoxylate)s of di- and tristyrylphenols,
h) polyethoxylates and poly(ethoxylate-co-propoxylate)s of alkylpolyglycosides or
i) mixtures thereof.

21. The active compound concentrate according to claim 17, wherein the polyether compound has a polyether radical of the formula III which is attached via oxygen to a C₈-C₂₂-alkyl radical, where R^{x} in formula III is hydrogen, EO is CH₂CH₂O, AO is CH₂CH(CH₃)O, x is a number whose number average is in the range of from 3 to 49, y is a number whose number average is in the range of from 1 to 47 and the number average of the sum x+y is in the range of from 5 to 50.

22. The active compound concentrate according to claim 21, wherein the polyether compound is selected from compounds of the general formula IV
R¹¹—O—[(EO)ₓ(AO)_{y}]—R^{x}, (IV)
in which R¹¹ is alkyl having 8 to 30 carbon atoms.

23. The active compound concentrate according to claim 17, comprising components a) and b) in the form of their dissolved alkali metal or ammonium salts.

24. The active compound concentrate according to claim 17, comprising a 4-benzoyl-substituted pyrazole compound of the formula I in which R² is selected from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the radicals mentioned above are unsubstituted or may carry 1 or 2 methyl groups as the substituents.

25. The active compound concentrate according to claim 24 wherein R¹ and R⁵ are each methyl, R² is 4,5-dihydroisoxazol-3-yl, R⁴ is methylsulfonyl and R⁶ is hydrogen.

26. The active compound concentrate according to claim 17, comprising a benzoic acid compound of the formula II in which R⁷ is methoxy and R⁸ is hydrogen.

27. The active compound concentrate according to claim 17, comprising
from 10 to 100 g/l of a 4-benzoyl-substituted pyrazole compound of the formula I,
from 50 to 250 g/l of a benzoic acid compound of the formula II,
from 100 to 500 g/l of at least one nonionic surfactant S and
water.

28. The active compound concentrate according to claim 17, comprising the 4-benzoyl-substituted pyrazole compound of the formula I and the benzoic acid compound of the formula II in a weight ratio of from 1:25 to 2:1.

29. A method for controlling unwanted vegetation which comprises preparing an aqueous spray liquor by diluting the active compound concentrate according to claim 17 and applying the spray liquor on plants, their seeds and/or their habitat and allowing the spray liquor to act on plants, their seeds and/or their habitat.

30. The method according to claim 29, which comprises treating the leaves of the unwanted plants with the aqueous spray liquor.

31. An adjuvant which comprises which comprises the aqueous active compound concentrate according to claim 17.
